(19) United States
(12) Patent Application Publication
(10) Pub. No.: US 2026/0003599 A1
(43) Pub. Date: Jan. 1, 2026

(54) Firmware Inventory Service

(71) Applicant: Oracle International Corporation, Redwood Shores, CA (US)

(72) Inventors: Shreyas Nagaraj Mahanthappa, Betonville, AR (US); John Jay Osswald, Chapel Hill, NC (US); Xi Lu, Redmond, WA (US); Sunil Vikram Soman, Seattle, WA (US); Gyanesh Sharma, Seattle, WA (US)

(73) Assignee: Oracle International Corporation, Redwood Shores, CA (US)

(21) Appl. No.: 18/758,351

(22) Filed: Jun. 28, 2024

(51) Int. Cl. G06F 8/65; G06F 8/71; G06F 11/30

(52) U.S. Cl. CPC G06F 8/65; G06F 11/3065; G06F 8/71; G06F 11/302

(57) ABSTRACT

Techniques for creating and using a firmware inventory service are disclosed. A firmware collection agent executing on a physical machine periodically collects information about the firmware of components on the physical machine at a collection frequency. The firmware information is provided to a firmware inventory service for storage in a searchable data repository. The firmware inventory service receives queries about the stored firmware information and displays firmware information responsive to the queries.

### TECHNICAL FIELD

The present disclosure relates to collecting and using firmware information for physical machines in a cloud computing environment. In particular, the present disclosure relates to using firmware collection agents within a physical machine to access the firmware information and transmit the firmware information for storage in a searchable data store.

### BACKGROUND

Cloud service providers provision large numbers of physical computing equipment (“physical machines”) and allocate the physical machines to customers. While the cloud service providers often maintain inventory lists of the hardware allocated to a customer and may have knowledge of initial configurations of firmware and software installed on the physical machines, firmware can be updated by the customer, often without the cloud service provider's knowledge.

Accessing the current firmware versions for components on a physical machine is a manual, non-standardized process that is not scalable for large numbers of physical machines. These manual processes also do not provide access to the history of firmware versions on a given component.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in accordance with one or more embodiments;

FIG. 7A illustrates an example set of operations for collecting and storing firmware information in accordance with one or more embodiments;

FIG. 7B illustrates an example set of operations for using stored firmware information in accordance with one or more embodiments;

FIG. 8 illustrates an example of stored firmware information in accordance with one or more embodiments; and

FIG. 9 illustrates an example of a machine learning process in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. FIRMWARE INVENTORY SERVICE ARCHITECTURE
5. POPULATING AND USING A FIRMWARE INVENTORY SERVICE
6. EXAMPLE EMBODIMENT
7. MACHINE LEARNING
8. PRACTICAL APPLICATIONS, ADVANTAGES, AND IMPROVEMENTS
9. MISCELLANEOUS; EXTENSIONS

### 1. GENERAL OVERVIEW

Cloud service providers may provide their customers a large number of physical computing resources, referred to as baremetal hosts or physical machines, within the cloud service provider's premises. Any given physical machine includes firmware that may affect the performance and/or security vulnerability of the physical machine.

One or more embodiments periodically collect information about firmware installed on a physical machine via a software agent executing on the physical machine. The firmware information can include a manufacturer, a version of the firmware, a time stamp of when the information was collected, and a customer associated with the physical machine. The information is collected periodically by a software agent executing on the physical device and transmitted to a firmware inventory service. The firmware inventory service adds the firmware information to the data store such that the history of firmware versions is preserved over the life of a component on a physical machine. The data store can be queried to identify specific physical machines having a version of firmware that may require an update for performance, compliance, or security reasons.

One or more embodiments described in this Specification and/or recited in the claims may not be included in this General Overview section.

### 2. CLOUD COMPUTING TECHNOLOGY

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

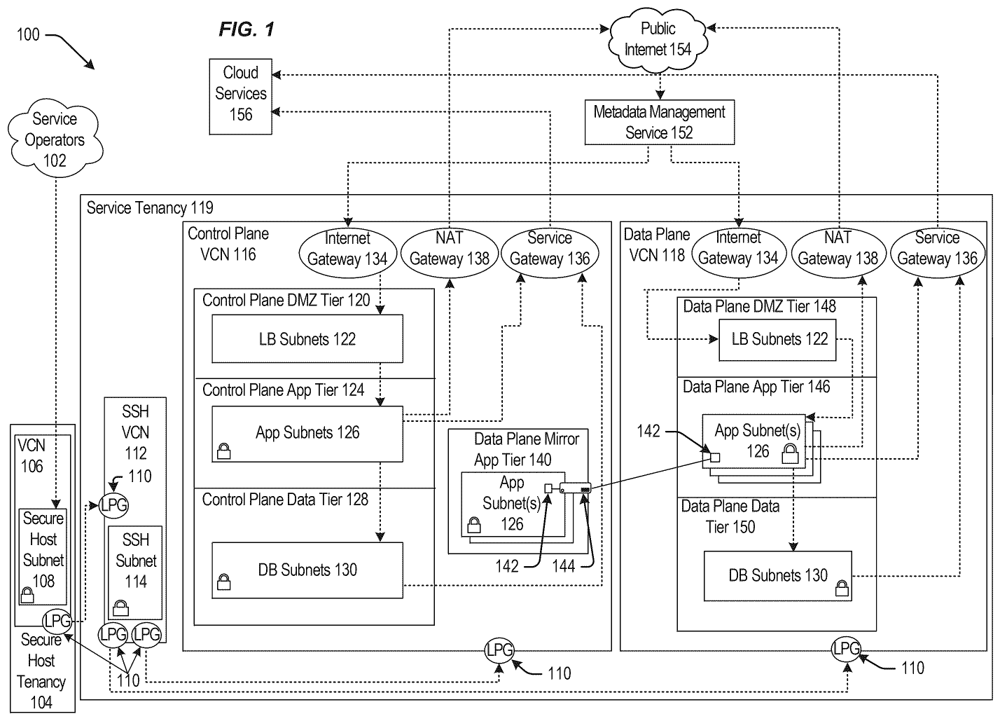

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

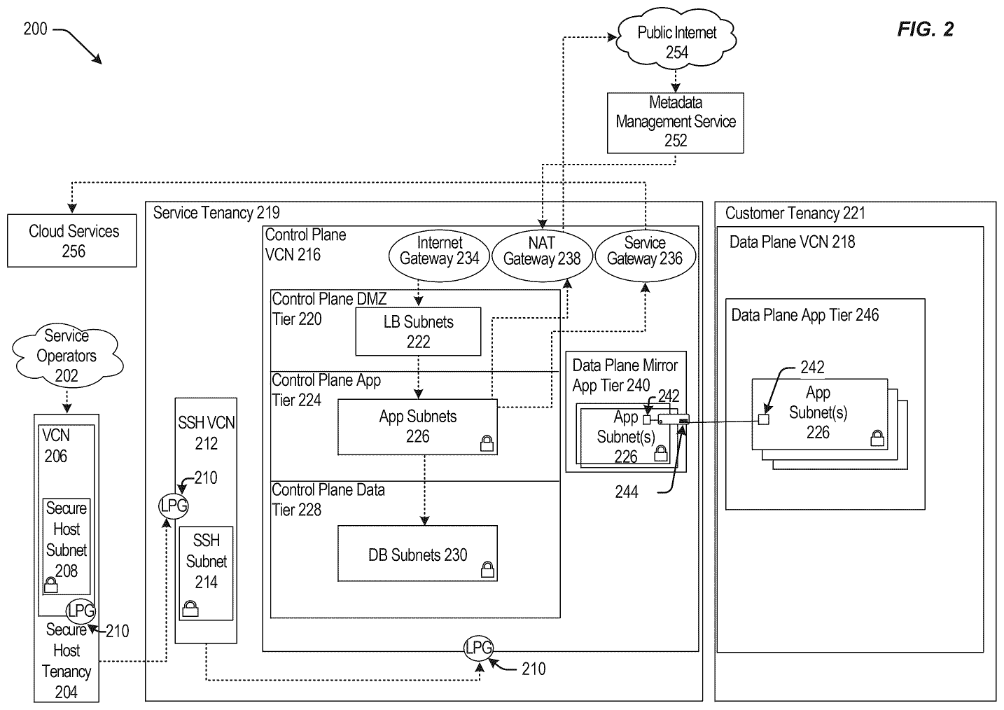

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

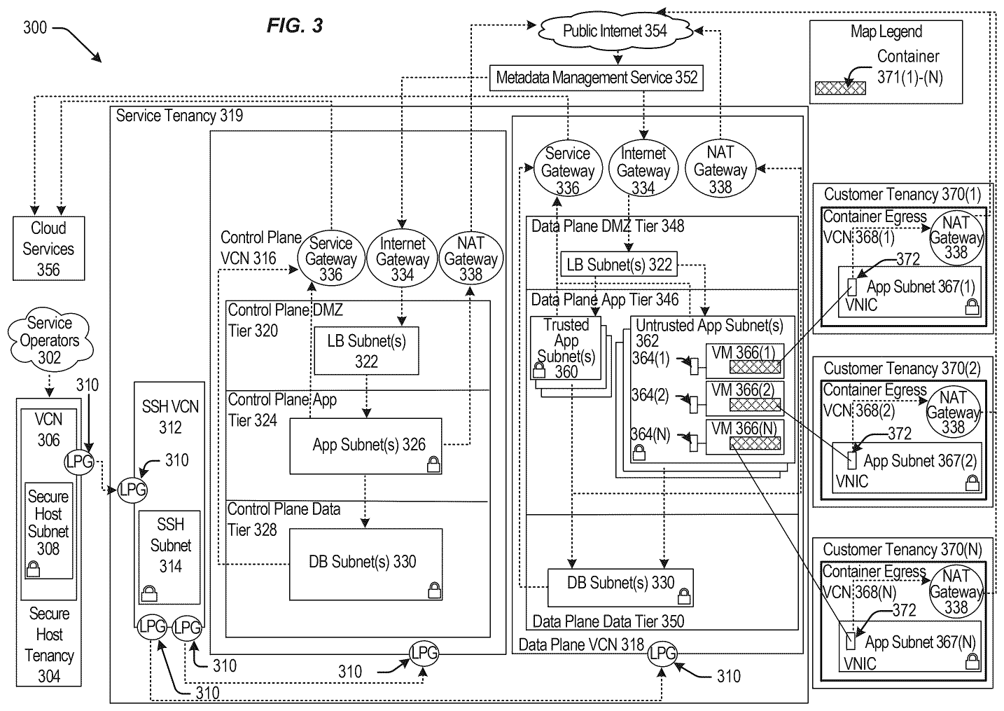

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

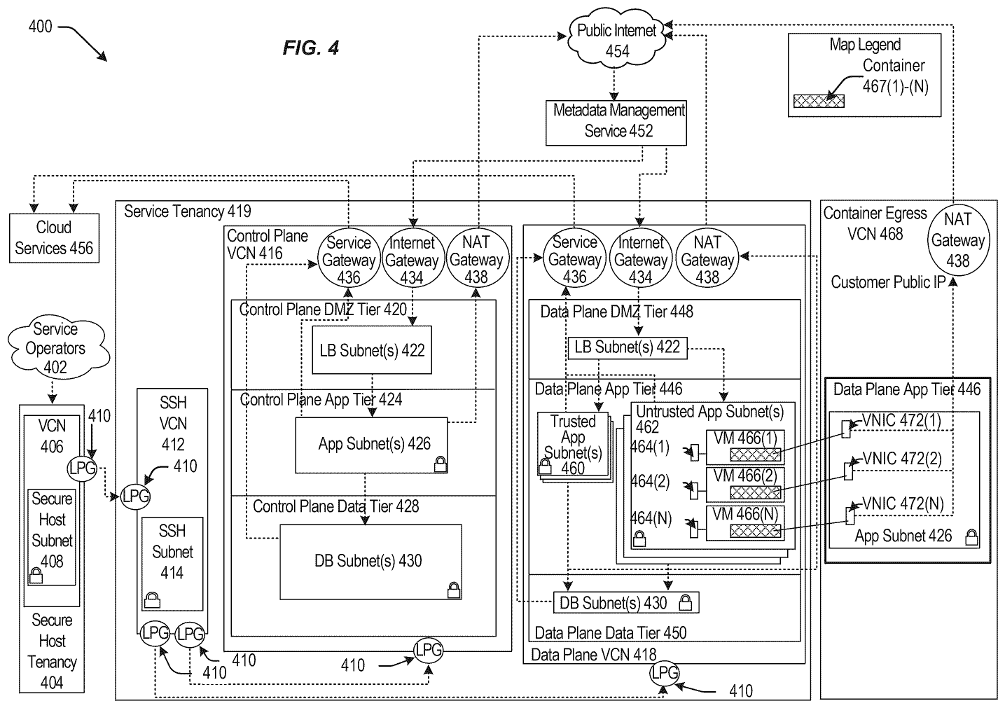

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for each tenant, a set of applications that the tenant is authorized to access. For each application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 4. COMPUTER SYSTEM

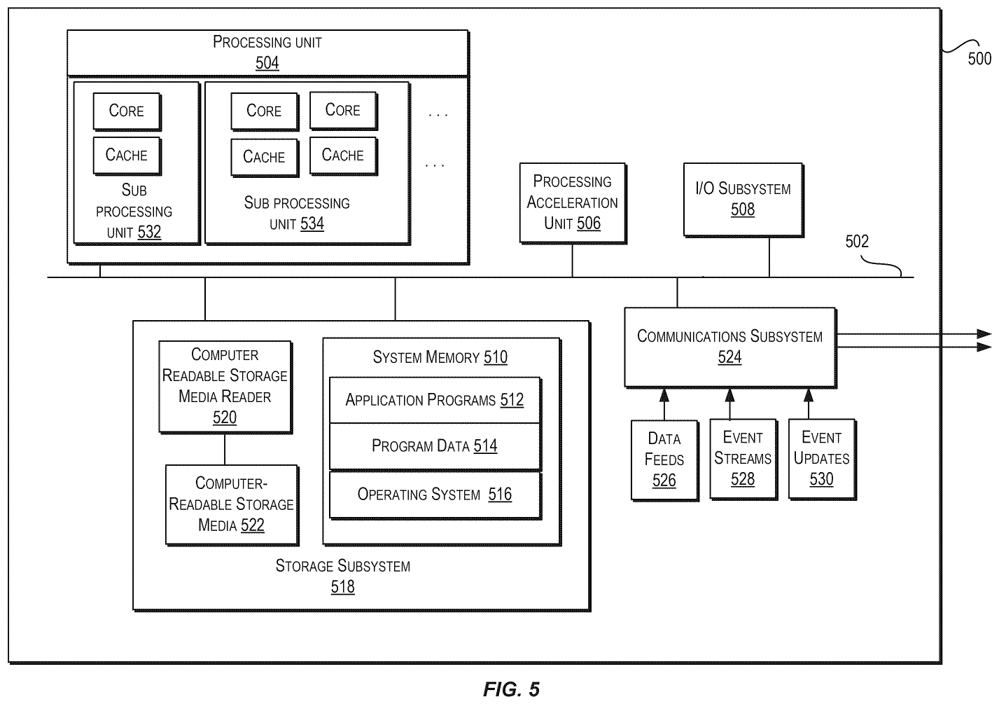

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. FIRMWARE INVENTORY SERVICE ARCHITECTURE

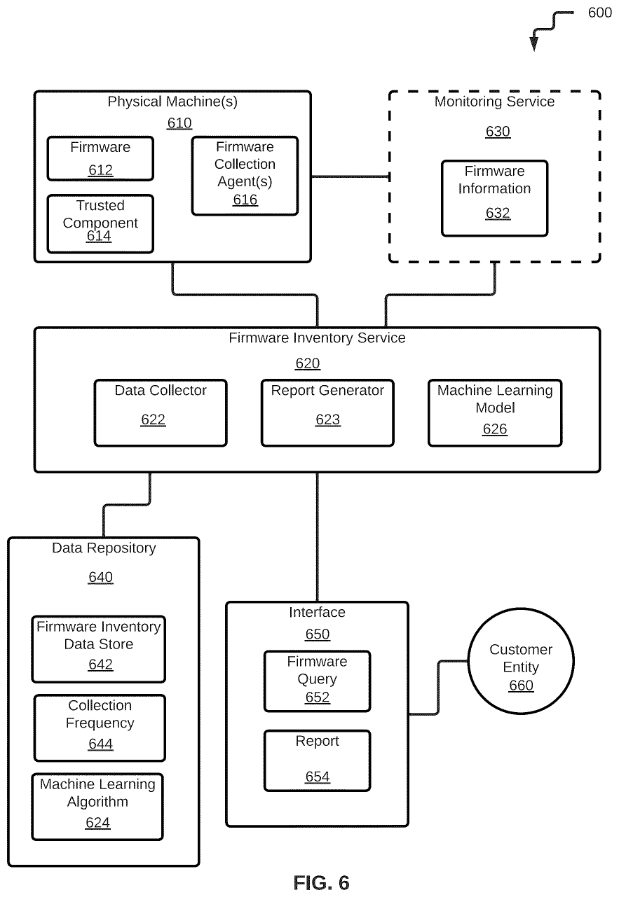

FIG. 6 illustrates a system 600 in accordance with one or more embodiments. As illustrated in FIG. 6, system 600 includes one or more physical machines 610, a firmware inventory service 620, a monitoring service 630, a data repository 640, and an interface 650. In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Components may be distributed over multiple applications and/or machines. Multiple components may be combined into one application and/or machine. Operations described with respect to one component may instead be performed by another component.

In one or more embodiments, a physical machine 610 refers to a collection of physical computing components operating as a single computer when allocated to a customer entity 660. The physical machine may include one or more bare-metal servers. The physical machine may be housed on the premises of a cloud service provider. The physical machine may be dedicated to a customer of the cloud service provider, meaning that the physical machine does not run workloads of other customers of the cloud service provider or run virtual machines of other customers. The customer has exclusive access to the physical computer's processing power, memory, storage. The customer has control over the server configuration and security settings of the physical machine. The physical machine operates within a virtual cloud network of the customer within the cloud environment. Further, the customer can choose the operating system for the physical machine. A service entity of the cloud service provider, e.g., network administrators, service technicians, or other individuals or business groups that service and maintain the physical machines, may have limited access to one or more components of the physical machine, for example, for monitoring and maintenance purposes.

A physical machine includes a variety of components, such as, but not limited to, a basic input/output system (BIOS), processing units, network interface cards, storage devices, and memory. An individual component may have firmware 612 embedded thereon. The embedded firmware 612 may have a version number and may be updatable.

A physical machine may also include a trusted component 614. A trusted component 614 may include, for example, an integrated lights out management (ILOM) component, a root of trust (RoT) component, and BIOS. In some embodiments, firmware installed on a trusted component may not be modifiable by a customer entity. A customer entity may be able to modify the firmware on other components on the physical machine.

A physical machine may include one or more firmware collection agents 616. A firmware collection agent 616 may be software that is configured to access firmware information on one or more of the components on the physical machine. The firmware collection agent 616 may be configured to provide the firmware information 632 to an optional monitoring service 630 or to the firmware inventory service 620.

One type of firmware collection agent 616 may be a component of an ILOM component. Another type of firmware collection agent 616 may be a hardware monitor that runs on a processor, for example, as a plugin. A hardware monitor firmware collection agent may need to be configured with permissions from the customer entity to allow the agent to access firmware information for some of the components on the physical machine. For example, a hardware monitor firmware collection agent may have an access token that allows the agent to access the firmware information. A hardware monitor firmware collection agent may access firmware information, in particular, for components, such as those connected by a PCI bus, that would not be accessible to a cloud service provider once the physical machine is allocated to a customer entity and in operation.

The firmware information 632 for a specific component may include one or more of the following: information that identifies the specific component, information that identifies the physical machine housing the specific component, a version number of the firmware of the specific component, a date/time stamp corresponding to when the firmware information was accessed, and an identifier of a customer entity 660 associated with the physical machine.

A firmware collection agent 616 may access the firmware information repeatedly at a defined collection frequency 644. In one or more embodiments, the collection frequency 644 is predefined, e.g., every 5 seconds, every 15 seconds, every 5 minutes, or every 15 minutes. In other embodiments, the collection frequency 644 is determined by a machine learning model based on one or more characteristics of a particular component or set of components. Some components may have firmware that needs to be updated often for optimal performance, compliance requirements, and/or security, while others may have firmware that rarely needs updates. The collection frequency 644 may determine how often the firmware information is accessed for some or all of the firmware on a physical machine. Alternatively, individual components or sets of components may have different collection frequencies such that the firmware information for one component may be accessed more frequently than the firmware information for a different component on the same physical machine.

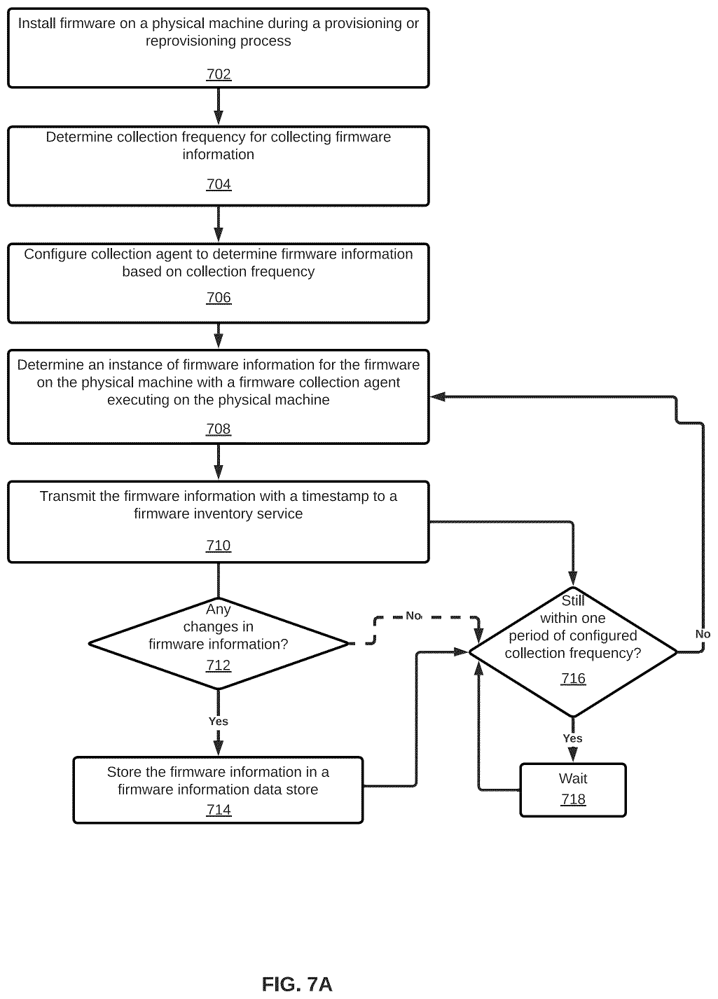

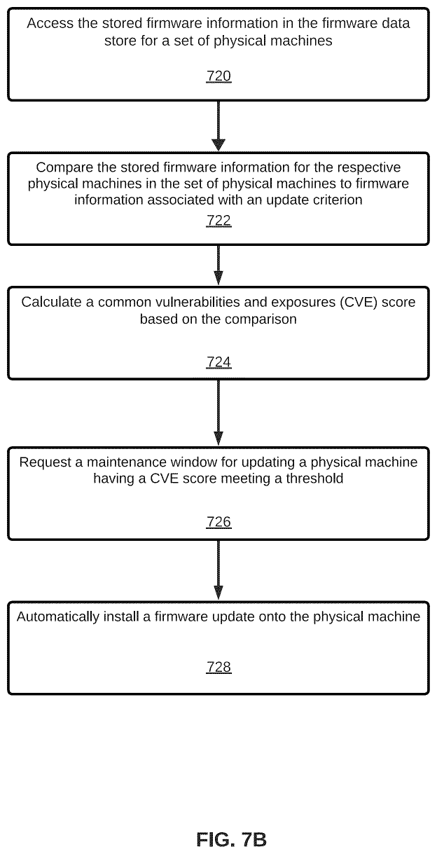

In one or more embodiments, the firmware inventory service 620 refers to hardware and/or software configured to perform operations described herein for collecting, storing, and using firmware information 632 about firmware 612 installed on the one or more physical machines 610. The firmware inventory service 620 may store the firmware information in a searchable data repository such as the firmware inventory data store 642. Examples of operations for collecting, storing, and using firmware information are described below with reference to FIGS. 7A and 7B. The firmware inventory service 620 may include one or more functional components, such as a data collector 622, a report generator 623, and a machine learning model 626. The firmware inventory service 620 may be controlled and operated by the cloud computing service provider that also provides the physical machines 610.

In one or more embodiments, the data collector 622 refers to hardware and/or software configured to perform operations described herein for collecting and storing the firmware information. The data collector 622 may receive the firmware information directly from the firmware collection agent(s) 616, for example, as a stream. The data collector 622 may receive the firmware information by pulling or requesting the firmware information from the firmware collection agent(s) 616 at the collection frequency 644.

In one or more embodiments, the report generator 623 refers to hardware and/or software configured to perform operations described herein for receiving a firmware query 652 and accessing the firmware inventory data store 642 to retrieve information responsive to the query. The report generator 623 may display the retrieved information as a report 654 via the interface 650. The report generator 623 may include an application program interface (API) that provides access to the firmware inventory data store via queries.

In one or more embodiments, an optional monitoring service 630 may operate as an intermediate repository for firmware information 632 from the firmware collection agent(s) 616. The frequency at which the data collector 622 obtains the firmware information 632 from the monitoring service 630 may be the same as the collecting frequency 644. Alternatively, the frequency may be different from the collecting frequency 644.

The firmware inventory data store 642 may include any portion or the entirety of the firmware information 632. In some cases, the stored firmware information may include identical records collected at different times. That is, a new record may be stored even if the firmware information for a specific component has not changed since the previous record was stored. In other cases, a new record may be stored if some aspect of the firmware information (other than the date/time stamp) has changed since the previous record was stored, but not if no aspects of the firmware information have changed.

In one or more embodiments, a data repository 640 is any type of storage unit and/or device (e.g., a file system, database, collection of tables, or any other storage mechanism) for storing data. Further, a data repository 640 may include multiple different storage units and/or devices. The multiple different storage units and/or devices may or may not be of the same type or located at the same physical site. Further, a data repository 640 may be implemented or executed on the same computing system as the firmware inventory service 620. Additionally, or alternatively, a data repository 640 may be implemented or executed on a computing system separate from the firmware inventory service 620. The data repository 640 may be communicatively coupled to the firmware inventory service 620 via a direct connection or via a network.

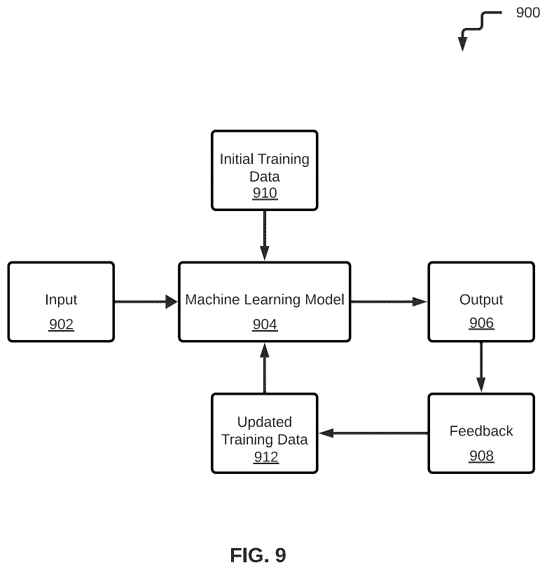

In one or more embodiments, a machine learning algorithm 624 is an algorithm that can be iterated to train a target model f that best maps a set of input variables to an output variable. In particular, a machine learning algorithm 624 is configured to generate and/or train a machine learning model 626. Machine learning model 626 may be trained to determine the collection frequency 644. Machine learning model 626 is described further with reference to FIG. 9.

Information describing the firmware inventory data store 642 and the machine learning algorithm 624 may be implemented across any of components within the system 600. However, this information is illustrated within the data repository 640 for purposes of clarity and explanation.

In an embodiment, the firmware inventory service 620 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 650 refers to hardware and/or software configured to facilitate communications between a user and the firmware inventory service 620. Interface 650 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

The interface 650 may present interface elements that permit a user, such as a customer entity 660 or a cloud computing service operator, to request information from the firmware inventory data store 642. For example, the interface 650 may provide an interface element that, when selected, causes the report generator 623 to retrieve a predefined set of firmware information. The interface 650 may present other interface elements that permit a user to select particular aspects of firmware information to retrieve. The interface 650 may then communicate the selection of the user interface elements as a firmware query 652 to the report generator 623. The interface 650 may present a report 654 from the report generator 623 responsive to the firmware query 652.

In an embodiment, different components of interface 650 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 650 is specified in one or more other languages, such as Java, C, or C++.

### 5. POPULATING AND USING A FIRMWARE INVENTORY SERVICE

FIG. 7A illustrates an example set of operations for collecting and storing firmware information in accordance with one or more embodiments. One or more operations illustrated in FIG. 7A may be modified, rearranged, or omitted. Accordingly, the particular sequence of operations illustrated in FIG. 7A should not be construed as limiting the scope of one or more embodiments.

In an embodiment, the system installs firmware on a physical machine during a provisioning or reprovisioning process (Operation 702). The system may execute a script or automated provisioning process to install firmware onto the components of the physical machine. If the physical machine was previously used, for example, by a different customer entity, the firmware may be updated as part of a reprovisioning process. The system may transmit information about the installed firmware to the firmware inventory service as part of the provisioning or reprovisioning process.

In an embodiment, the system determines a collection frequency for collecting firmware information (Operation 704). In one or more embodiments, the collection frequency may be predetermined and fixed. In other embodiments, a machine learning model may determine a collection frequency based on the particular combination of components on the physical machine. For example, if a manufacturer for a particular component often releases firmware updates, the machine learning model may set a collection frequency that has a shorter period relative to a collection frequency for a component whose firmware is rarely updated. The machine learning model may determine the collection frequency as an aggregation of individual collection frequencies, for example, as an average or a weighted average of different individual collection frequencies.

In an embodiment, the system configures a collection agent to determine firmware information based on the collection frequency (Operation 706). The system may set a value for the collection frequency within a firmware collection agent. The system may set a value for the collection frequency externally to the firmware collection agents and provide a reference or link to the externally set value for the collection frequency to the firmware collection agents.

In an embodiment, the system determines an instance of firmware information for the firmware on the physical machine with a firmware collection agent executing on the physical machine (Operation 708). A firmware collection agent may access a component and read version information from the firmware on the component. A firmware agent may determine whether or not to use a standard LINUX utility or a vendor-specific firmware access tool to access the firmware information based on configuration information about the particular component in a shape definition for the physical machine.

An ILOM-based software agent may access firmware information for the ILOM, BIOS, nonvolatile memory express (NVME), ROT components, and/or some HostNIC components. A hardware monitor-type firmware collection agent, with permission from the customer entity, may access firmware information for other components, including the following: other HostNIC components; disk arrays, e.g., Just a Bunch of Disks (JBOD) and serial ATA (SATA) hard drives; host bus adapters (HBA); GPUs; and/or SmartNICs. The firmware collection agent may create and populate a temporary data structure with the collected firmware information for transmission to the firmware inventory service.

In an embodiment, the system provides the firmware information with a timestamp to a firmware inventory service (Operation 710). The system may transmit, stream, or push, the firmware information to the firmware inventory service at the collection frequency. Additionally, or alternatively, the system may provide the firmware information to the firmware inventory service when the firmware information is requested or pulled by the firmware inventory service.

The system may transmit, or push, the firmware information to an intermediate monitoring service at the collection frequency. Additionally, or alternatively, the system may provide the firmware information to the intermediate monitoring service when the firmware information is requested or pulled by the intermediate monitoring service. The system may then transmit, stream, or push, the firmware information from the intermediate monitoring service to the firmware inventory service. Additionally, or alternatively, the system may provide the firmware information to the firmware inventory service from the intermediate monitoring service when the firmware information is requested or pulled by the firmware inventory service.

In an embodiment, the system determines if there are changes in the firmware information for the physical machine (Operation 712). The system may calculate a hash value from the firmware information for a physical machine and compare that hash value to a hash value of a previously collected instance of firmware information. The system may directly compare a version number in the currently collected instance of firmware information to a version number in a previously collected instance of firmware or to a stored version number. If there are no changes to the firmware information, the system may optionally proceed to Operation 716 instead of to Operation 714.

In an embodiment, the system stores the firmware information in a firmware information data store (Operation 714). The system may create a new record in the data store that includes the collected firmware information. If there were no changes to the firmware information, the system may update the timestamp of an existing record that includes the same firmware information rather than create a new record.

In an embodiment, the system determines if the current time is still within the same period of the collection frequency that included Operation 708 (Operation 716). For example, if the collection frequency is every two minutes, the system may compare a current time to the timestamp of the last collected firmware instance to determine if two minutes have elapsed since the timestamp.

In an embodiment, the system waits until the end of the current period of the collection frequency before returning to Operation 708 (Operation 718).

FIG. 7B illustrates an example set of operations for using stored firmware information in accordance with one or more embodiments. One or more operations illustrated in FIG. 7B may be modified, rearranged, or omitted. Accordingly, the particular sequence of operations illustrated in FIG. 7B should not be construed as limiting the scope of one or more embodiments.

In an embodiment, the system accesses the stored firmware information in the firmware inventory data store for a set of physical machines (Operation 720). The system may access the stored firmware information in response to a query from a customer entity or from a cloud service operator for firmware information. The query may be for a complete history of firmware versions for one or more components on a particular physical machine or a group of physical machines. The query may be for a history of firmware versions for a range of dates for one or more components on a particular physical machine or a group of physical machines. The query may be for a listing of physical machines that have a component with a specific firmware version or a specific range of firmware versions. The system may search the firmware inventory data store for records that meet the query criteria. The system may display the accessed firmware information via an interface.

In an embodiment, the system compares the stored firmware information for the respective physical machines in the set of physical machines to firmware information associated with an update criterion (Operation 722). The update criterion may include a latest firmware version available for a component. The update criterion may include a specific firmware version, for example, a version known to include errors, or a version known to have security vulnerabilities. The update criterion may be included in a query for accessing the firmware inventory data store. The system may identify records corresponding to physical machines that have firmware that meets the update criterion, e.g., physical machines having the firmware version known to include errors. The system may identify records corresponding to physical machines that have firmware that does not meet the update criterion, e.g., physical machines with firmware versions earlier than the latest firmware version available. The system may raise an alert when there are physical machines that have firmware that is associated with the update criterion, for example, by sending a message to a service entity at the cloud service operator or at the customer entity. The system may display information corresponding to the physical machines that have firmware that is associated with the update criterion.

In an embodiment, the system calculates a common vulnerabilities and exposures (CVE) score based on the comparison (Operation 724). For example, for physical machines with firmware versions earlier than the latest firmware version available, the system may calculate a CVE score for an individual physical machine that reflects how out of date the machine's firmware is. The system may have access to a set of the different firmware versions that are available for a component and may base the CVE score on the number of firmware versions that exist between a physical machine's current firmware version and the latest firmware version available. The system may base the CVE score on a comparison of the numbers in a physical machine's current firmware version and the latest firmware version available, e.g., a difference between firmware version 12.6.2.3 and 12.5.7.1.

The system may prioritize physical machines for updates according to their respective CVE scores. Physical machines having higher CVE scores may be prioritized for updates ahead of physical machines having lower CVE scores.

In an embodiment, the system requests a maintenance window for updating a physical machine having a CVE score meeting a threshold (Operation 726). For physical machines that meet or exceed a CVE score threshold corresponding to a critical need for updating, the system may interact directly or indirectly with the associated customer entity to request a maintenance window during which the update can be installed. Requesting the maintenance window provides the customer entity the opportunity to stop using the affected physical machine(s) so that the physical machine(s) can be restarted if needed during and update.

For physical machines having CVE scores that do not meet the threshold, the system may generate a report that identifies the physical machines that may still need updates, but less urgently. The system may add an update request for these physical machines to a regularly scheduled maintenance process.

In an embodiment, the system automatically installs a firmware update onto the physical machine (Operation 728). The system may wait until the maintenance window and then install the update. The system may cause a provisioning system or a maintenance system to install the update. When the firmware version on a physical machine is more than one version out of date, the system may install intermediate firmware versions in succession before installing the latest available firmware version.

In one or more embodiments, the system can access the firmware inventory data store when reprovisioning a physical machine for a different customer. The system can, for example, determine if the installed firmware on a physical machine is the latest version, and if so, can skip a firmware installation or updating step in the reprovisioning process.

When a customer entity requests a firmware history for one or more of the physical machines allocated to the customer entity, the system may identify a time period during which the one or more of the physical machines were allocated to the customer entity. The system may retrieve records for the firmware history of the one or more physical machines having timestamps that occur during the identified time period. Stored firmware information that predates the identified time period may not be accessed or retrieved for the customer entity.

In an embodiment, the system receives a request for a firmware inventory report that includes one or more firmware criteria. For example, the request may be for a listing of the firmware versions currently in use for one or more components on one or more physical machines. The request may be for a listing of the physical machines that are using a particular firmware version on a particular type of component. The system may access the stored firmware information and select records having stored firmware information that meets the one or more firmware criteria. The system may generate the requested firmware inventory report with the information from the selected records.

### 6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

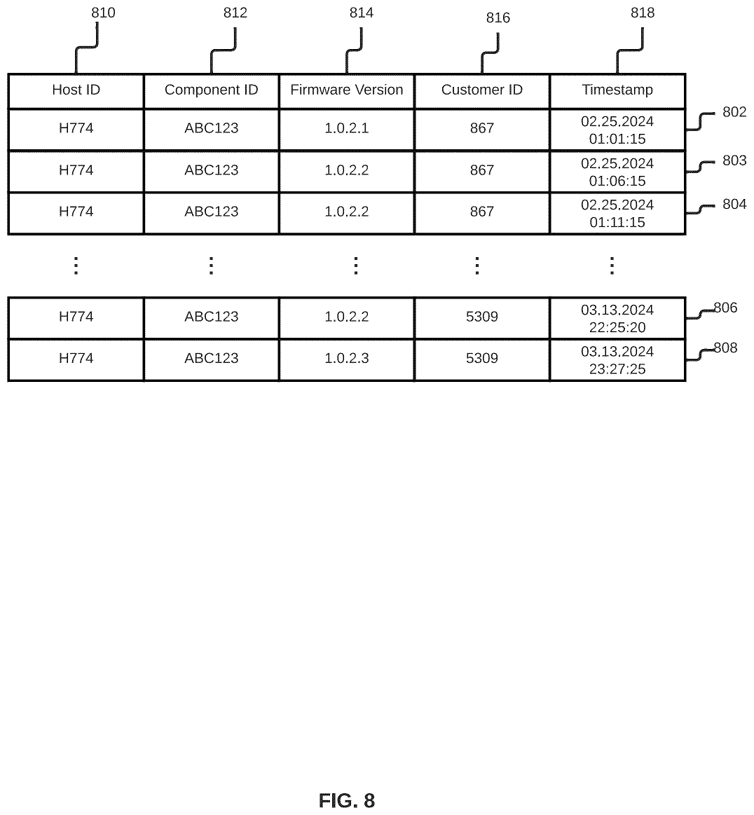

FIG. 8 illustrates an example of stored firmware information. An individual data record, e.g., record 802, may correspond to one component on one physical machine. In one or more embodiments, a data record includes values for a host ID 810, a component ID 812, a firmware version 814, a customer ID 816, and a timestamp 818. The host ID 810 may identify the specific physical machine where the component is housed. The component ID 812 may identify the specific component on the physical machine. The component ID 812 may be a serial number or an inventory control number, for example. The firmware version 814 may identify the version of the firmware present on the specific component when the firmware information was accessed by a firmware collection agent. The customer ID 816 may identify a customer entity that was associated with the specific physical machine when the firmware information was accessed by a firmware collection agent. The timestamp 818 may identify the date and time when the firmware information was accessed by a firmware collection agent.

In some embodiments, a record may not include the customer ID directly. Instead, the firmware information data store, or another data store, may include a separate record of dates and times when a given customer entity has ownership and control of a physical machine and the components on the physical machine. In some embodiments, a record may not include the host ID directly. Instead, the firmware information data store, or another data store, may include a separate record of what components are included on a particular physical machine.

In the illustrated example, the firmware version for the component “ABC123” has changed between records 802 and 803, reflecting an update. There is no change to the firmware version between records 803 and 804. In some embodiments, record 804 may not be stored since there is no change from the previous record. At some point between records 804 and 806, the physical machine “H774” was unassigned from the customer ID “867” and reprovisioned and reassigned to customer ID “5309”. Then, between records 806 and 808, the firmware version for the component “ABC123” was updated.

### 7. MACHINE LEARNING

FIG. 9 illustrates a machine learning process 900 according to one or more embodiments. A machine learning model 904 may be iteratively trained on initial training data 910 to set a collection frequency. The initial training data 910 may include, for example, one or more of the following: how frequently new versions of firmware for a component are released by a manufacturer; a level of security vulnerability for a component; a level that reflects how error-prone a component is; how many other components are dependent on the component; and/or how many other components the component depends on.

Once trained initially, the machine learning model 904 may act on an input 902 such as a component listing for a physical machine. The output 906 may be a collection frequency collecting the firmware information for the physical machine and/or for an individual component on the physical machine.

The training data may be updated based on, for example, feedback 908 on the accuracy of the current machine learning model 904 and/or on how often the firmware for a component was actually updated. Updated training data 912 is fed back into the machine learning algorithm that, in turn, updates the machine learning model 904.

A machine learning model 904 is trained such that the model best fits the datasets of training data to the labels or outputs of the training data. Additionally, or alternatively, machine learning model 904 is trained such that when the model is applied to the datasets of the training data, a maximum number of results determined by the model matches the labels or outputs of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 8. PRACTICAL APPLICATIONS, ADVANTAGES, AND IMPROVEMENTS

When a cloud service provider initially provisions or reprovisions a physical machine for a customer, the cloud service provider may have knowledge of the firmware on the physical machine at the time of provisioning. Once a physical machine is operating and under customer control, the customer may update the firmware independently of the cloud service provider. The cloud service provider may be unaware of the updates. If a problem arises with the physical machines, the cloud service provider may not have knowledge of the current versions of firmware on the customer's machines and may not be able to provide appropriate support in a timely manner.

Conventionally, a cloud service operator needs to log in to the customer's system and run device-specific commands to check the firmware version on a given instance to obtain the firmware versions. Identifying and upgrading the firmware version may vary by device and often by the manufacturer. Some device manufacturers allow standard Linux utilities to read and upgrade the firmware version, while others require using vendor-specific tools. A customer may have tens or hundreds of thousands of instances. If a customer or the cloud service operator needs to view a large number of the customer's instances, it is impractical, if not impossible, to run the various device-specific commands instance by instance. Obtaining a firmware installation history is similarly impractical, for most components do not keep track of their firmware history. The problem is compounded when the problem is critical and time sensitive. Furthermore, some firmware information may not be accessible to a human operator, in particular, once the physical machine is running.

The disclosed embodiments improve on conventional practices with the use of firmware collection agents executing on the physical machines that can access and transmit firmware information to a firmware inventory service. The firmware collection agents can access firmware information for components not accessible by an external query. The firmware inventory service stores the firmware information in a searchable data store. Customers and cloud service operators alike can access the stored information, for example, to obtain a firmware inventory of a fleet of physical machines, obtain a firmware history, identify non-compliant firmware, identify security or other risks due to firmware, and to prioritize updates.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. One or more non-transitory computer-readable media comprising computer-executable instructions that, when executed by one or more processors of a computer system, cause the one or more processors to perform operations comprising:
executing a firmware collection agent on a physical machine;
determining, by the firmware collection agent, firmware information about firmware on the physical machine at a configured collection frequency, wherein determining the firmware information comprises:
determining at a first time, by the firmware collection agent, a first instance of the firmware information about the firmware on the physical machine; and
determining at a second time, by the firmware collection agent, a second instance of the firmware information about the firmware on the physical machine, wherein a difference between the first time and the second time is based on the configured collection frequency;
transmitting, by the firmware collection agent to a firmware inventory service, the first instance of the firmware information and the second instance of the firmware information; and
displaying at least a subset of the firmware information via a user interface that is communicatively coupled to the firmware inventory service.

2. The non-transitory media of claim 1, wherein the operations further comprise:
obtaining, by the firmware collection agent, permission from a customer associated with the physical machine to collect the firmware information on the physical machine.

3. The non-transitory media of claim 1, wherein the physical machine operates within a cloud environment provided by a cloud service provider and the physical machine is dedicated to a customer of the cloud service provider.

4. The non-transitory media of claim 3, wherein at least a portion of the firmware information cannot be accessed by a human operator at the cloud service provider.

5. The non-transitory media of claim 1, wherein the operations further comprise executing the firmware collection agent on a BIOS of the physical machine.

6. The non-transitory media of claim 1, the operations further comprising: using a machine learning model to determine the configured collection frequency for the firmware collection agent to collect and transmit the firmware information.

7. The non-transitory media of claim 1, the operations further comprising:
Storing the firmware information, by the firmware inventory service, in a searchable data repository.

8. The non-transitory media of claim 7, the operations further comprising:
accessing the stored firmware information from the searchable data repository;
comparing the stored firmware information to firmware information associated with an update criterion; and
raising an alert when the comparing indicates that the stored firmware information meets the update criterion.

9. The non-transitory media of claim 8, the operations further comprising:
calculating a common vulnerabilities and exposures (CVE) score based on the comparing;
assigning a priority level to one or more physical machines according to the respective CVE scores associated with the respective one or more physical machines; and
automatically installing a firmware update onto the one or more physical machines according to the respective priority levels of the one or more physical machines.

10. The non-transitory media of claim 7, the operations further comprising:
receiving a request for a firmware history for the firmware on a physical machine from a first customer;
accessing the stored firmware information for the physical machine; and
generating a firmware history for the physical machine, the firmware history including the firmware information collected during a first time frame when the physical machine was associated with the first customer.

11. The non-transitory media of claim 10, wherein the firmware information includes an indication of a customer associated with the physical machine at a time of the collecting; and wherein generating the firmware history does not include firmware information collected during a second time frame when the physical machine was associated with a different customer.

12. The non-transitory media of claim 7, the operations further comprising:
receiving a request for a firmware inventory report, the request including one or more firmware criteria;
accessing the stored firmware information for a plurality of physical machines;
selecting the stored firmware information that meets the one or more firmware criteria; and
generating the firmware inventory report according to the selected stored firmware information.

13. The non-transitory media of claim 7, the operations further comprising:
accessing the stored firmware information for a physical machine identified for one of provisioning or re-provisioning;
determining that the firmware on the physical machine is up-to-date based on the stored firmware information;
skipping a firmware update process for the physical machine based on the determining; and
collecting and transmitting, by the firmware collection agent, the firmware information about firmware on the physical machine to the firmware inventory service when the provisioning or re-provisioning is performed.

14. The non-transitory media of claim 1, the operations further comprising:
executing a plurality of firmware collection agents on a corresponding plurality of physical machines;
determining, by the plurality of firmware collection agents, respective firmware information about respective firmware on the plurality of physical machines at the configured collection frequency; and
transmitting, by the plurality of firmware collection agents to the firmware inventory service, the respective firmware information, wherein the firmware inventor service maintains a searchable data repository of the firmware information corresponding to the plurality of machines.

15. The non-transitory media of claim 1, wherein the operations comprise executing the firmware collection agent on an integrated lights out manager of the physical machine.

16. The non-transitory media of claim 1, wherein the first instance of the firmware information is identical to the second instance of the firmware information; the operations further comprising:
determining at a third time, by the firmware collection agent, a third instance of the firmware information about the firmware on the physical machine, wherein the second instance of the firmware information is different from the third instance of the firmware information; and
transmitting, by the firmware collection agent to the firmware inventory service, (a) at least one of the first instance of the firmware information and the second instance of the firmware information, and (b) the third instance of the firmware information.

17. A method comprising:
executing a firmware collection agent on a physical machine;
determining, by the firmware collection agent, firmware information about firmware on the physical machine at a configured collection frequency, wherein collecting the firmware information comprises:
determining at a first time, by the firmware collection agent, a first instance of the firmware information about firmware on the physical machine; and
determining at a second time, by the firmware collection agent, a second instance of the firmware information about firmware on the physical machine, wherein a difference between the first time and the second time is based on the configured collection frequency;
transmitting, by the firmware collection agent to a firmware inventory service, the first instance of the firmware information and the second instance of the firmware information; and
displaying at least a subset of the firmware information via a user interface that is communicatively coupled to the firmware inventory service;
wherein the method is performed by at least one device including a hardware processor.

18. The method of claim 17, further comprising: using a machine learning model to determine the configured collection frequency for the firmware collection agent to collect and transmit the firmware information.

19. The method of claim 17, further comprising: storing the firmware information, by the firmware inventory service, in a searchable data repository.

20. A system comprising:
at least one device including a hardware processor;
the system being configured to perform operations comprising:
executing a firmware collection agent on a physical machine;
determining, by the firmware collection agent, firmware information about firmware on the physical machine at a configured collection frequency, wherein collecting the firmware information comprises:
determining at a first time, by the firmware collection agent, a first instance of the firmware information about firmware on the physical machine; and
determining at a second time, by the firmware collection agent, a second instance of the firmware information about firmware on the physical machine, wherein a difference between the first time and the second time is based on the configured collection frequency;
transmitting, by the firmware collection agent to a firmware inventory service, the first instance of the firmware information and the second instance of the firmware information; and
displaying at least a subset of the firmware information via a user interface that is communicatively coupled to the firmware inventory service.
